(19) United States
(12) Patent Application Publication
(10) Pub. No.: US 2011/0072404 A1
(43) Pub. Date: Mar. 24, 2011

(54) Parallel Timing Analysis For Place-And-Route Operations

(76) Inventor: Prasanna V. Srinivas, Cupertino, CA (US)

(21) Appl. No.: 12/566,652

(22) Filed: Sep. 24, 2009

(51) Int. Cl. G06F 17/50

(52) U.S. Cl. 716/108

(57) ABSTRACT

Signal paths in a circuit design are identified, and each node in each path to be processed by an electronic design automation operation is assigned a value. More particularly, each node in a signal path to be processed is sequentially assigned an incrementing value. If a node occurring in multiple signal paths already has been assigned a value, and the new value to be assigned to the node is higher than its previously-assigned value, then the node is assigned the higher value. Two or more portions of the circuit design having the same assigned node values are then processed in parallel by the electronic design automation operation.

### RELATED APPLICATIONS

This application claims priority under 35 U.S.C. §119 to U.S. Provisional Patent Application No. 61/099,516, entitled “Parallel Timing Analysis For Place-And-Route Operations,” filed on Sep. 24, 2008, and naming Preasanna Venkat Srinivas as inventor, which application is incorporated entirely herein by reference.

### FIELD OF THE INVENTION

The present invention is directed to the partitioning of circuit design data so that the resulting parts can be operated upon in parallel by an electronic design automation process. Various implementations of the invention may be particularly useful for partitioning circuit design data for parallelization of timing analysis in a place and route operation.

### BACKGROUND OF THE INVENTION

Electronic circuits, such as integrated microcircuits, are used in a variety of products, from automobiles to microwaves to personal computers. Designing and fabricating microcircuit devices typically involves many steps, known as a “design flow.” The particular steps of a design flow often are dependent upon the type of microcircuit being designed, its complexity, the design team, and the microcircuit fabricator or foundry that will manufacture the microcircuit. Typically, software and hardware “tools” will verify a design at various stages of the design flow by running software simulators and/or hardware emulators, and errors in the design are corrected.

Several steps are common to most design flows. Initially, the specification for the new microcircuit is transformed into a logical design, sometimes referred to as a register transfer level (RTL) description of the circuit. With this logical design, the circuit is described in terms of both the exchange of signals between hardware registers and the logical operations that are performed on those signals. The logical design typically employs a Hardware Design Language (HDL), such as the Very high speed integrated circuit Hardware Design Language (VHDL). The logical of the circuit is then analyzed, to confirm that the logic incorporated into the design will accurately perform the functions desired for the circuit. This analysis is sometimes referred to as “functional verification.”

After the accuracy of the logical design is confirmed, it is converted into a device design by synthesis software. The device design, which is typically in the form of a schematic or netlist, describes the specific electronic devices (such as transistors, resistors, and capacitors) that will be used in the circuit, along with their interconnections. This logical generally corresponds to the level of representation displayed in conventional circuit diagrams. Preliminary timing estimates for portions of the circuit may be made at this stage, using an assumed characteristic speed for each device. In addition, the relationships between the electronic devices are analyzed, to confirm that the circuit described by the device design will correctly perform the functions desired for the circuit. This analysis is sometimes referred to as “formal verification.”

Once the relationships between circuit devices have been established, the design is again transformed, this time into a physical design that describes specific geometric elements. This type of design often is referred to as a “layout” design. The geometric elements define the shapes that will be created in various materials to actually manufacture the circuit device components (e.g., contacts, gates, etc.) making up the circuit. While the geometric elements are typically polygons, other shapes, such as circular and elliptical shapes, also may be employed. These geometric elements may be custom designed, selected from a library of previously-created designs, or some combination of both. Geometric elements also are added to form the connection lines that will interconnect these circuit devices. Layout tools (often referred to as “place and route” tools), such as the Olympus SoC and IC Station layout software tools available from Mentor Graphics Corporation of Wilsonville, Oreg., or the Virtuoso layout software tool available from Cadence Design Systems of San Jose, Calif., are commonly used for both of these tasks.

With a layout design, each physical layer of the microcircuit will have a corresponding layer representation, and the geometric elements described in a layer representation will define the relative locations of the circuit device components that will make up a circuit device. Thus, the geometric elements in the representation of an implant layer will define the regions where doping will occur, while the geometric elements in the representation of a metal layer will define the locations in a metal layer where conductive wires used will be formed to connect the circuit devices. Typically, a designer will perform a number of analyses on the layout design. For example, the layout design may be analyzed to confirm that it accurately represents the circuit devices and their relationships described in the device design. The layout design also may be analyzed to confirm that it complies with various design requirements, such as minimum spacings between geometric elements. Still further, it may be modified to include the use of redundant or other compensatory geometric elements intended to counteract limitations in the manufacturing process, etc.

After the layout design has been finalized, then it is converted into a format that can be employed by a mask or reticle writing tool to create a mask or reticle for use in a photolithographic manufacturing process. Masks and reticles are typically made using tools that expose a blank reticle to an electron or laser beam. Most mask writing tools are able to only “write” certain kinds of polygons, however, such as right triangles, rectangles or other trapezoids. Moreover, the sizes of the polygons are limited physically by the maximum beam aperture size available to the tool. Accordingly, larger geometric elements in the layout design, or geometric elements that are not basic right triangles, rectangles or trapezoids (which typically is a majority of the geometric elements in a layout design) must be “fractured” into the smaller, more basic polygons that can be written by the mask or reticle writing tool.

Once the layout design has been fractured, then the layout design data can be converted to a format compatible with the mask or reticle writing tool. Examples of such formats are MEBES, for raster scanning machines manufactured by ETEC, an Applied Materials Company, the “.MIC” format from Micronics AB in Sweden, and various vector scan formats for Nuflare, JEOL, and Hitachi machines, such as VSB12 or VSB12. The written masks or reticles can then be used in a photolithographic process to expose selected areas of a wafer in order to produce the desired integrated circuit devices on the wafer.

As previously noted, an electronic design automation tool that transforms a logical circuit design into a physical design is sometimes referred to as a “place-and-route tool.” Part of the function of this type of tool is to “place” the design representations of physical circuit components in a geographical relationship to each other, and then to “route” the design representations of the interconnect lines that will electrically connect the physical components. With some implementations, a place-and-route tool may place high-level circuit components, such as flip-flops and logic gates. For still other implementations, a place-and-route tool may place relatively fundamental circuit components, such as transistors, diodes, resistors, capacitors and inductors. Regardless of the components being placed, a significant issue for most place-and-route tools is timing. If two circuit components are placed too far apart, a signal sent from one component may not be able to reach the other component fast enough to satisfy a design requirement. Further, the timing of some signals may be more critical than other signals in the design.

In order to address these timing concerns, a place-and-route tool will perform a timing analysis process for various signal paths in the circuit design. Timing analysis may include, for example, some combination of parasitic extraction, delay calculation, MCMM-SI (multi-corner multi-mode signal integrity) analysis, or other types of timing-related calculations used to measure the delays in the propagation of signals through signal paths in the design. Timing analysis is typically very time-consuming, however. A signal path between two end points in a circuit may pass through a number of intermediate circuit components. Moreover, virtually every change in the component layout or interconnect wiring can impact timing in complex ways. As a result, timing analysis calculations tend to take more time in the overall design cycle than any other design step. Further, the design delays caused by timing analysis calculations are only expected to increase as integrated circuit designs become more complex.

Various attempts have been made to perform timing calculations in parallel using multiple computing processes. These attempts have not been successful because of heavy dependency between the circuit points (e.g., device connection pins) being analyzed. More particularly, timing analysis requires pins further upstream in a signal path to be analyzed before the pins further downstream in that signal path. Whenever the sequential nature of the analysis process is broken, non-deterministic behavior may occur. Non-determinism means that at any given step in the analysis, there could be more than one result, making the analysis unreliable. Some electronic design automation tools provide multithreaded timing analysis for multi-corner multi-mode designs by performing the analysis for different mode/corner combinations in parallel. For example, one timing analysis process may perform a timing analysis on a circuit design for, e.g., a mobile telephone, assuming that the circuit is in a standby mode and in a high temperature environment. Another timing analysis process may perform a timing analysis on the circuit design assuming that the circuit is in a transmit mode and in a low temperature environment. With these conventional tools, however, the timing analysis for each individual mode/corner combination must still be performed by sequentially analyzing all of the pins in the design data using a single timing analysis process.

### BRIEF SUMMARY OF THE INVENTION

Aspects of the invention relate to partitioning circuit design data into various segments. With various examples of the invention, a circuit design is partitioned such that two or more of the segments are independent with respect to a particular electronic design automation process, such as a timing analysis process.

According to various implementations of the invention, the signal paths in a circuit design are identified, and each node in a path to be processed by an electronic design operation is assigned a value. With some implementations of the invention, the nodes may be the input and output pins for components in the circuit. Still other implementations of the invention may additionally or alternately assign values to other types of circuit features designated as a node by a user. Each node sequentially is assigned an incrementing value. If a node occurring in multiple signal paths already has been assigned a value, and the new value to be assigned to the node is higher than its previously-assigned value, then the node is assigned the higher value.

By assigning a value to the nodes for each signal path, the circuit design is partitioned into segments corresponding to each node such that the segments having corresponding node values are independent from each with respect to, for example, a timing analysis process. For example, if the nodes are assigned numerical values, then all of the nodes having the same value (e.g., circuit component pins assigned a value of “9”) are independent with respect to a timing analysis process. That is, this partitioning and value assignment ensures that a signal output from any pin assigned a value of “9” will not be an input to any other pin assigned a value of “9.” These and other features of the invention will be apparent from the following description.

### BRIEF DESCRIPTION OF THE DRAWINGS

FIG. 1 illustrates an example of a multiprocessor parallel computing system that can be used to implement various embodiments of the invention.

FIG. 2 illustrates an example of a processor unit that may be employed in a parallel computing system used to implement various embodiments of the invention.

FIG. 3 illustrates an example of a timing analysis tool that may be implemented according to various embodiments of the invention.

FIG. 4 illustrates the partitioning of circuit design that made by a timing analysis tool that may be implemented according to various embodiments of the invention.

FIG. 5 illustrates a flowchart describing the operation of an analysis tool that may be implemented according to various embodiments of the invention.

### DETAILED DESCRIPTION OF EMBODIMENTS OF THE INVENTION

### Overview

As will be discussed in more detail below, various embodiments of the invention are related to electronic design automation. In particular, various implementations of the invention may be used to partition and label circuit design data so that the resulting parts can be operated upon in parallel by an electronic design automation process. As used herein, the terms “design” and “design data” are intended to encompass data describing an entire integrated circuit device. This term also is intended to encompass a smaller set of data describing one or more components of an entire integrated circuit device, however, such as a layer of an integrated circuit device, or even a portion of a layer of an integrated circuit device. Still further, the terms “design” and “design data” also are intended to encompass data describing more than one integrated circuit device, such as data to be used to create a mask or reticle for simultaneously forming multiple integrated circuit device on a single wafer. It should be noted that, unless otherwise specified, the term “design” as used herein is intended to encompass any type of design, including both a physical layout design and a logical design.

### Exemplary Operating Environment

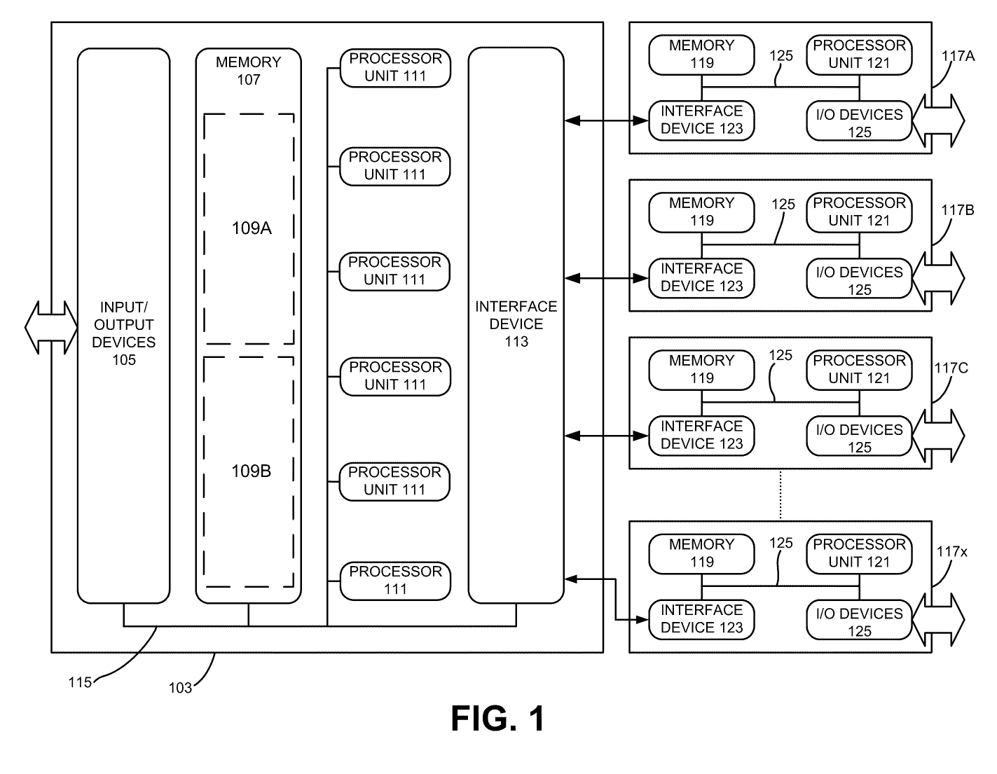

The execution of various electronic design automation processes according to embodiments of the invention may be implemented using computer-executable software instructions executed by one or more programmable computing devices. Because these embodiments of the invention may be implemented using software instructions, the components and operation of a generic programmable computer system on which various embodiments of the invention may be employed will first be described. Further, because of the complexity of some electronic design automation processes and the large size of many circuit designs, various electronic design automation tools are configured to operate on a computing system capable of simultaneously running multiple processing threads. The components and operation of a computer network having a host or master computer and one or more remote or servant computers therefore will be described with reference to FIG. 1. This operating environment is only one example of a suitable operating environment, however, and is not intended to suggest any limitation as to the scope of use or functionality of the invention.

In FIG. 1, the computer network 101 includes a master computer 103. In the illustrated example, the master computer 103 is a multi-processor computer that includes a plurality of input and output devices 105 and a memory 107. The input and output devices 105 may include any device for receiving input data from or providing output data to a user. The input devices may include, for example, a keyboard, microphone, scanner or pointing device for receiving input from a user. The output devices may then include a display monitor, speaker, printer or tactile feedback device. These devices and their connections are well known in the art, and thus will not be discussed at length here.

The memory 107 may similarly be implemented using any combination of computer readable media that can be accessed by the master computer 103. The computer readable media may include, for example, microcircuit memory devices such as read-write memory (RAM), read-only memory (ROM), electronically erasable and programmable read-only memory (EEPROM) or flash memory microcircuit devices, CD-ROM disks, digital video disks (DVD), or other optical storage devices. The computer readable media may also include magnetic cassettes, magnetic tapes, magnetic disks or other magnetic storage devices, punched media, holographic storage devices, or any other medium that can be used to store desired information.

As will be discussed in detail below, the master computer 103 runs a software application for performing one or more operations according to various examples of the invention. Accordingly, the memory 107 stores software instructions 109A that, when executed, will implement a software application for performing one or more operations. The memory 107 also stores data 109B to be used with the software application. In the illustrated embodiment, the data 109B contains process data that the software application uses to perform the operations, at least some of which may be parallel.

The master computer 103 also includes a plurality of processor units 111 and an interface device 113. The processor units 111 may be any type of processor device that can be programmed to execute the software instructions 109A, but will conventionally be a microprocessor device. For example, one or more of the processor units 111 may be a commercially generic programmable microprocessor, such as Intel® Pentium® or Xeon™ microprocessors, Advanced Micro Devices Athlon™ microprocessors or Motorola 68K/Coldfire® microprocessors. Alternately or additionally, one or more of the processor units 111 may be a custom-manufactured processor, such as a microprocessor designed to optimally perform specific types of mathematical operations. The interface device 113, the processor units 111, the memory 107 and the input/output devices 105 are connected together by a bus 115.

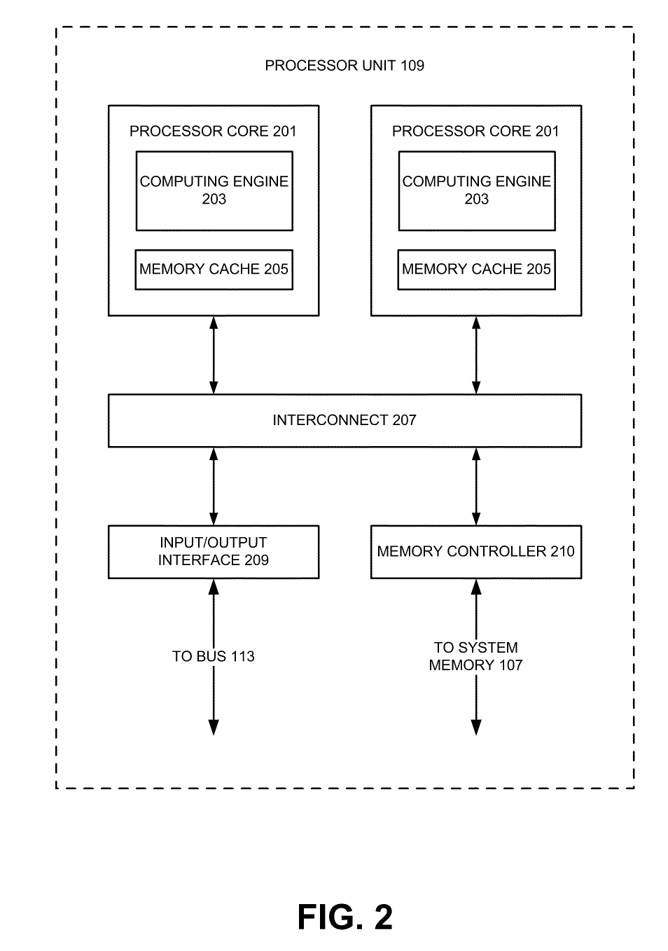

With some implementations of the invention, the master computing device 103 may employ one or more processing units 111 having more than one processor core. Accordingly, FIG. 2 illustrates an example of a multi-core processor unit 111 that may be employed with various embodiments of the invention. As seen in this figure, the processor unit 111 includes a plurality of processor cores 201. Each processor core 201 includes a computing engine 203 and a memory cache 205. As known to those of ordinary skill in the art, a computing engine contains logic devices for performing various computing functions, such as fetching software instructions and then performing the actions specified in the fetched instructions. These actions may include, for example, adding, subtracting, multiplying, and comparing numbers, performing logical operations such as AND, OR, NOR and XOR, and retrieving data. Each computing engine 203 may then use its corresponding memory cache 205 to quickly store and retrieve data and/or instructions for execution.

Each processor core 201 is connected to an interconnect 207. The particular construction of the interconnect 207 may vary depending upon the architecture of the processor unit 201. With some processor cores 201, such as the Cell microprocessor created by Sony Corporation, Toshiba Corporation and IBM Corporation, the interconnect 207 may be implemented as an interconnect bus. With other processor units 201, however, such as the Opteron™ and Athlon™ dual-core processors available from Advanced Micro Devices of Sunnyvale, Calif., the interconnect 207 may be implemented as a system request interface device. In any case, the processor cores 201 communicate through the interconnect 207 with an input/output interface 209 and a memory controller 211. The input/output interface 209 provides a communication interface between the processor unit 201 and the bus 115. Similarly, the memory controller 211 controls the exchange of information between the processor unit 201 and the system memory 107. With some implementations of the invention, the processor units 201 may include additional components, such as a high-level cache memory accessible shared by the processor cores 201.

While FIG. 2 shows one illustration of a processor unit 201 that may be employed by some embodiments of the invention, it should be appreciated that this illustration is representative only, and is not intended to be limiting. For example, some embodiments of the invention may employ a master computer 103 with one or more Cell processors. The Cell processor employs multiple input/output interfaces 209 and multiple memory controllers 211. Also, the Cell processor has nine different processor cores 201 of different types. More particularly, it has six or more synergistic processor elements (SPEs) and a power processor element (PPE). Each synergistic processor element has a vector-type computing engine 203 with 428×428 bit registers, four single-precision floating point computational units, four integer computational units, and a 556 KB local store memory that stores both instructions and data. The power processor element then controls that tasks performed by the synergistic processor elements. Because of its configuration, the Cell processor can perform some mathematical operations, such as the calculation of fast Fourier transforms (FFTs), at substantially higher speeds than many conventional processors.

It also should be appreciated that, with some implementations, a multi-core processor unit 111 can be used in lieu of multiple, separate processor units 111. For example, rather than employing six separate processor units 111, an alternate implementation of the invention may employ a single processor unit 111 having six cores, two multi-core processor units each having three cores, a multi-core processor unit 111 with four cores together with two separate single-core processor units 111, etc.

Returning now to FIG. 1, the interface device 113 allows the master computer 103 to communicate with the servant computers 117A, 117B, 117C . . . 117x through a communication interface. The communication interface may be any suitable type of interface including, for example, a conventional wired network connection or an optically transmissive wired network connection. The communication interface may also be a wireless connection, such as a wireless optical connection, a radio frequency connection, an infrared connection, or even an acoustic connection. The interface device 113 translates data and control signals from the master computer 103 and each of the servant computers 117 into network messages according to one or more communication protocols, such as the transmission control protocol (TCP), the user datagram protocol (UDP), and the Internet protocol (IP). These and other conventional communication protocols are well known in the art, and thus will not be discussed here in more detail.

Each servant computer 117 may include a memory 119, a processor unit 121, an interface device 123, and, optionally, one more input/output devices 125 connected together by a system bus 127. As with the master computer 103, the optional input/output devices 125 for the servant computers 117 may include any conventional input or output devices, such as keyboards, pointing devices, microphones, display monitors, speakers, and printers. Similarly, the processor units 121 may be any type of conventional or custom-manufactured programmable processor device. For example, one or more of the processor units 121 may be commercially generic programmable microprocessors, such as Intel® Pentium® or Xeon™ microprocessors, Advanced Micro Devices Athlon™ microprocessors or Motorola 68K/Coldfire® microprocessors. Alternately, one or more of the processor units 121 may be custom-manufactured processors, such as microprocessors designed to optimally perform specific types of mathematical operations. Still further, one or more of the processor units 121 may have more than one core, as described with reference to FIG. 2 above. For example, with some implementations of the invention, one or more of the processor units 121 may be a Cell processor. The memory 119 then may be implemented using any combination of the computer readable media discussed above. Like the interface device 113, the interface devices 123 allow the servant computers 117 to communicate with the master computer 103 over the communication interface.

In the illustrated example, the master computer 103 is a multi-processor unit computer with multiple processor units 111, while each servant computer 117 has a single processor unit 121. It should be noted, however, that alternate implementations of the invention may employ a master computer having single processor unit 111. Further, one or more of the servant computers 117 may have multiple processor units 121, depending upon their intended use, as previously discussed. Also, while only a single interface device 113 or 123 is illustrated for both the master computer 103 and the servant computers, it should be noted that, with alternate embodiments of the invention, either the computer 103, one or more of the servant computers 117, or some combination of both may use two or more different interface devices 113 or 123 for communicating over multiple communication interfaces.

With various examples of the invention, the master computer 103 may be connected to one or more external data storage devices. These external data storage devices may be implemented using any combination of computer readable media that can be accessed by the master computer 103. The computer readable media may include, for example, microcircuit memory devices such as read-write memory (RAM), read-only memory (ROM), electronically erasable and programmable read-only memory (EEPROM) or flash memory microcircuit devices, CD-ROM disks, digital video disks (DVD), or other optical storage devices. The computer readable media may also include magnetic cassettes, magnetic tapes, magnetic disks or other magnetic storage devices, punched media, holographic storage devices, or any other medium that can be used to store desired information. According to some implementations of the invention, one or more of the servant computers 117 may alternately or additionally be connected to one or more external data storage devices. Typically, these external data storage devices will include data storage devices that also are connected to the master computer 103, but they also may be different from any data storage devices accessible by the master computer 103.

It also should be appreciated that the description of the computer network illustrated in FIG. 1 and FIG. 2 is provided as an example only, and it not intended to suggest any limitation as to the scope of use or functionality of alternate embodiments of the invention.

### Timing Analysis Tool

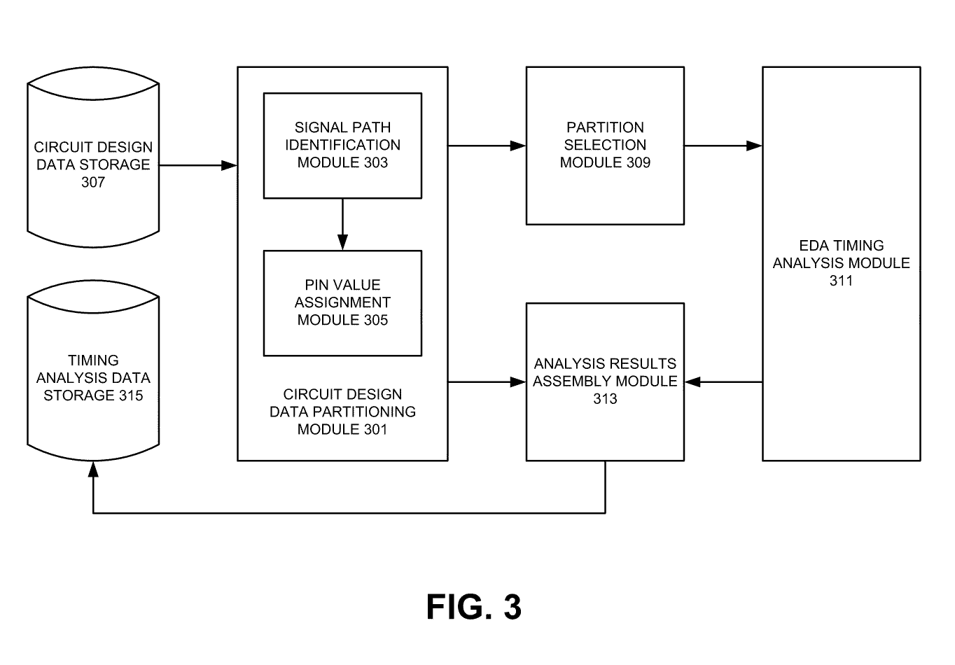

FIG. 3 illustrates an example of a timing analysis tool that may be implemented according to various embodiments of the invention. As seen in this figure, the timing analysis tool includes a circuit design data partitioning module 301, which itself includes a signal path identification module 303 and a pin value assignment module 305. The circuit design data partitioning module 301 obtains circuit design data from a circuit design data storage 307. As will be discussed in more detail below, the circuit design data partitioning module 301 partitions the circuit design data into segments. The partition selection module 309 then selects one or more segments of the circuit design, and provides the segment or segments to the EDA timing analysis module 311 for processing. As will also be discussed in more detail below, the partition selection module 309 selects portions of the circuit design data so that each portion is independent from the other portions with regard to the EDA timing analysis operation, so that the EDA timing analysis module 311 can process the segments in parallel. Once the EDA timing analysis module 311 has processed the circuit design data segments, it returns the results of the analyses to the analysis results assembly module 313. The analysis results assembly module 313 assembles the timing analysis results for the various circuit design data segments, and stores the results in the timing analysis data storage 315.

It should be appreciated that, with various embodiments of the invention, one of more of the circuit design data partitioning module 301, the partition selection module 309, the EDA timing analysis module 311, and the analysis results assembly module 313 may be implemented by a programmable computer executing software instructions so as to provide a special purpose device for performing one or more functions of an embodiment of the invention. Alternately, with various embodiments of the invention, one of more of the circuit design data partitioning module 301, the partition selection module 309, the EDA timing analysis module 311, and the analysis results assembly module 313 may be implemented by software instructions stored on a computer-readable medium for programming a computer to provide a special purpose device for performing one or more functions of an embodiment of the invention.

Also, while each of the circuit design data partitioning module 301, the partition selection module 309, the EDA timing analysis module 311, and the analysis results assembly module 313 are illustrated as separate modules in FIG. 3, alternate implementations of the invention may combine the functionality of one or more of these modules into any desired module arrangement. Similarly, while the signal path identification module 303 and pin value assignment module 305 are illustrated as separate modules in FIG. 3, alternate implementations of the invention may combine the functionality of one or both of these modules into any desired module arrangement, including combinations that have the functionality of one or more of each of the circuit design data partitioning module 301, the partition selection module 309, the EDA timing analysis module 311, and the analysis results assembly module 313.

With regard to the circuit design data storage 307 and the timing analysis data storage 315, these storage units can be implemented using any conventional desired storage device including, for example, an optical disk drive, a magnetic disk drive, and/or an integrated circuit memory storage device. Also, while the circuit design data storage 307 and the timing analysis data storage 315 are illustrated as different storage units, various examples of the invention can combine a part or the entirety of each of these storage units. Also, while the illustrated example of the invention includes the EDA timing analysis module 311, other implementations of the invention may alternately or additionally include other electronic design automation processes.

### Circuit Design Partitioning Module

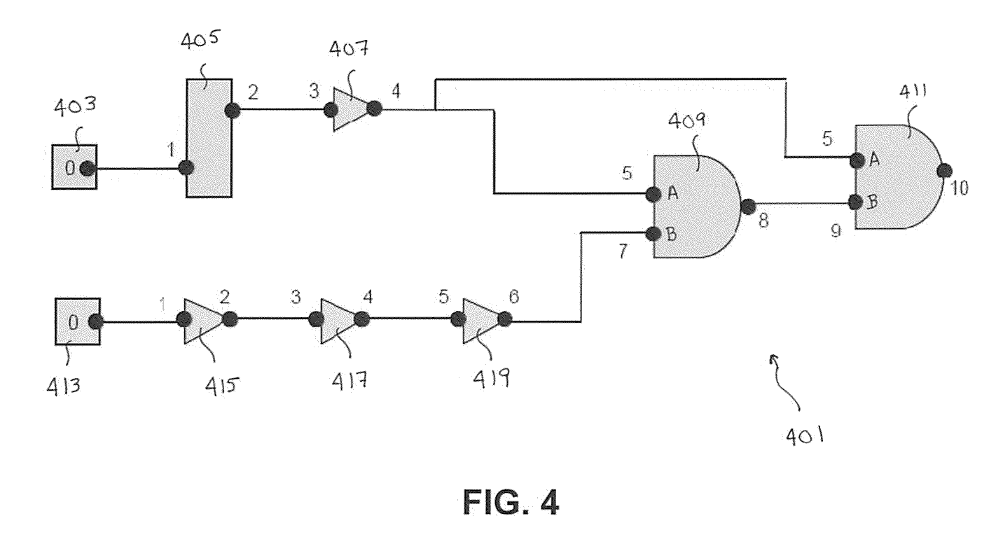

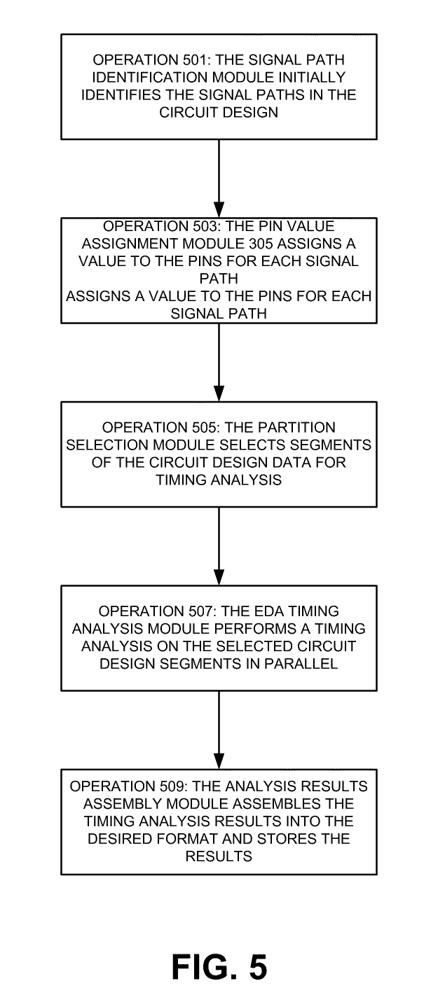

The circuit design data partitioning module 301 will now be described in more detail with reference to FIGS. 4 and 5. FIG. 4 illustrates an example of a circuit design 401 including a number of circuit components 403-419, each having one or more connection pins. (With various examples of the invention, both the input pins and the output pins of a circuit design may be considered a circuit component.)

Referring now to FIG. 5, in operation 501, the signal path identification module 303 initially identifies the signal paths in the circuit design 401. As will be appreciated by those of ordinary skill in art, the circuit design 401 has three signal paths, as follows:
h 1: From the circuit input pin 403 to the input pin of component 405, from the input pin of component 405 to the output pin of component 405, from the output pin of component 405 to the input pin of component 407, from the input pin of component 407 to the output pin of component 407, from the output pin of component 407 to the input pin A of the component 411, and from the input pin A of the component 411 to the output pin of the component 411.
Path 2: From the circuit input pin 403 to the input pin of component 405, from the input pin of component 405 to the output pin of component 405, from the output pin of component 405 to the input pin of component 407, from the input pin of component 407 to the output pin of component 407, from the output pin of component 407 to the input pin A of the component 409, from the input pin A of the component 409 to the output pin of the component 409, from the output pin of component 409 to the input pin B of the component 411, and from the input pin B of the component 411 to the output pin of the component 411.
Path 3: From the circuit input pin 413 to the input pin of component 415, from the input pin of component 415 to the output pin of component 415, from the output pin of component 415 to the input pin of component 417, from the input pin of component 417 to the output pin of component 417, from the output pin of component 417 to the input pin of the component 419, from the input pin of the component 419 to the output pin of the component 419, from the output pin of component 419 to the input pin B of the component 409, from the input pin B of the component 409 to the output pin of the component 409, from the output pin of component 409 to the input pin B of the component 411, and from the input pin B of the component 411 to the output pin of the component 411.

With various implementations of the invention, the signal path identification module 303 can use any desired conventional technique to identify the signal paths in a circuit design. For example, some implementations of the invention may use one or more conventional tree data structure analysis techniques for identifying the signal paths in a circuit design.

Once the signal path identification module 303 has identified the signal paths, in operation 503 the pin value assignment module 305 assigns a value to the pins for each signal path. More particularly, the pin value assignment module 305 assigns an initial value to the first pin in a signal path, and then increments that value by a set amount (e.g., by an amount of “1”) for each subsequent pin in the signal path. If the pin value assignment module 305 determines that a pin has already been assigned a value that is higher than the next incremented value in the signal path, it keeps the higher value and increments from that higher value for the next subsequent pin in the signal path.

For example, referring to FIG. 4, when the pin value assignment module 305 assigns values to the pins in the signal path 1, it may assign an initial value of “0” to the circuit input pin 403. It will then assign a value of “1” to the input pin of component 405, a value of “2” to the output pin of component 405, a value of “3” to the input pin of component 407, a value of “4” to the output pin of component 407, a value of “5” to the input pin A of the component 411, and a value of “6” to the output pin of the component 411.

Next, when the pin value assignment module 305 assigns values to the pins in the signal path 2, it will assign an initial value of “0” to the circuit input pin 403. As this pin has already been assigned the value of “0”, it will maintain this value for the circuit input pin 403. Similarly, the pin value assignment module 305 will maintain the previously established values for the input pin of component 405, the output pin of component 405, and the output pin of component 407. Continuing along signal path 2, the pin value assignment module 305 will assign a value of “5” to the input pin A of the component 409, a value of “6” to the output pin of the component 409, and a value of “7” to the input pin B of the component 411. The pin value assignment module 305 will then attempt to assign a value of “8” to the output pin of the component 411. While the pin value assignment module 305 has previously assigned this pin a value of “6” when processing signal path 1, it determines that the new value is higher than the previously-established value, and assigns the output pin of the component 411 the higher value of “8.”

When the pin value assignment module 305 next assigns values to the pins in the signal path 3, it will assign an initial value of “0” to the circuit input pin 413. (It should be noted that, with various embodiments of the invention, the circuit inputs will each be assigned the same initial value.) The pin value assignment module 305 will then assign a value of “1” to the input pin of component 415, a value of “2” to the output pin of component 415, a value of “3” to the input pin of component 417, a value of “4” to the output pin of component 417, a value of “5” to the input pin of the component 419, a value of “6” to the output pin of the component 419, and a value of “7” to the input pin B of the component 409.

The pin value assignment module 305 reaches the output pin of the component 409, it will then attempt to assign a value of “8” to this pin. While the pin value assignment module 305 has previously assigned this pin a value of “6” when processing signal path 2, it determines that the new value is higher than the previously-established value, and assigns the output pin of the component 409 the higher value of “8.” Similarly, when the pin value assignment module 305 reaches the input pin B of the component 411, it will then attempt to assign a value of “9” to this pin. Again, after it determines that the new value is higher than the previously-assigned value, the pin value assignment module 305 will change the value of this pin from “7” to “9.” The pin value assignment module 305 will then likewise change the value assigned to the output pin of the component 411 from “8” to “10,” as illustrated in FIG. 4.

In this manner, each pin in the circuit design is assigned a value according to its sequence in the signal paths in which that pin occurs. It should be appreciated that, for circuit design data describing a more circuit complex circuit having more signals paths and pins that the circuit design 401, the signal path identification module 303 will identify the signal paths in the circuit design data and the pin value assignment module 305 will sequentially assign an incrementing value to the pins of each signal path to be analyzed.

After the pins in each signal path to be analyzed have been assigned a value, the circuit design is partitioned into segments corresponding to each pin. Further, the pin value assignment module 305 has identified segments that are independent from each other with respect to a timing analysis operation. More particularly, based upon the values assigned by the pin value assignment module 305, the pin segments having the same assigned values are independent from each other with respect to a timing analysis operation. For example, if the nodes are assigned numerical values, then all of the nodes having the same value (e.g., circuit component pins assigned a value of “9”) are independent with respect to a timing analysis operation. That is, this partitioning technique ensures that a signal output from any pin assigned a value of “9” will not be an input to any other pin assigned a value of “9.”

It should be appreciated that various implementations of the invention may use any type of value to sequentially number the pins in a signal path. For example, while the illustrated examples employ a numerical value, alternate implementations of the invention may employ any desired alphabetic values when those values. Still further, while the illustrated examples employ an incremental amount of “1,” alternate implementations of the invention may employ any incremental amount (e.g., “2,” “3,” “4,” etc.), provided that the incremental amount is employed consistently for all of the signal paths to be analyzed in the circuit design.

Also, it should be noted that various implementations of the invention may segment circuit design data based upon nodes other than (or in addition to) circuit component pins. For example, some implementations of the invention may designate nodes at fixed lengths along the signal paths, at only the input pins of circuit components, at only the output pins of circuit components, at the edges of geometrical elements in a layout design, etc.

### Partition Selection And Timing Analysis

Once the circuit design data partitioning module 301 has partitioned the circuit design data and identified data segments that are independent from each other with respect to a timing analysis operation, the partition selection module 309 selects segments of the circuit design data for timing analysis in operation 505. More particularly, the partition selection module 309 selects segments of the circuit design data that are independent from each other with respect to the timing analysis operation performed by the EDA timing analysis module 311. Then, in operation 507, the EDA timing analysis module 311 performs a timing analysis on the selected circuit design segments in parallel (i.e., using timing analysis processes that execute independent of each other, and can execute at the same time).

With various examples of the invention, the partition selection module 309 can select segments of the circuit design data in a manner appropriate to the timing analysis process to be performed by the EDA timing analysis module 311. For example, if the timing analysis operation is to be performed at the pin level, the partition selection module 309 may select all a plurality of pins assigned the same pin value (e.g., “1”). With a typical timing analysis, the partition selection module 309 may select all of the pins in a circuit design that have been assigned a value of “1.” Because these pins are independent, the EDA timing analysis module 311 can analyze each of the pins in parallel. Once all of the pins having an assigned value of “1” have been processed, the partition selection module 309 may then select all of the pins in the design that have been assigned a value of “2.” Again, because these pins are independent from each other with respect to the timing analysis being performed by the EDA timing analysis module 311, the EDA timing analysis module 311 can analyze each of the pins assigned a value of “2” in parallel. Various examples of the invention may continue to select and analyze the pins in groups according to their incrementing assigned values (e.g., all of the pins have a value of “3,” then all of the pins have a value of “4,” then all of the pins have a value of “5,” etc.), until all of the pins in the circuit design having assigned values have been analyzed by the EDA timing analysis module 311.

As should be appreciated by those of ordinary skill in the art, parallel timing analysis processes can be performed by the EDA timing analysis module 311 using the processing units of a distributed computing network like the computing network 101. It should be appreciated that various implementations of the invention may employ any desired scheduling technique for assigning the selected circuit design segments to parallel timing analysis processes. For example, some implementations of the invention may create a pool of unprocessed circuit design segments having a common assigned value. As a timing analysis process becomes available, it can obtain and operate on one or more of the selected segments until it has analyzed those segments. Of course, still other, more complex parallel processing scheduling techniques alternately or additionally may be employed with other implementations of the invention, including scheduling techniques that take into account the number of computing processor units available to execute a timing analysis process.

Depending upon the type of timing analysis (or other EDA process) being performed, with various implementations the partition selection module 309 may select segment groups that are independent from each other with respect to that EDA process. For example, in some implementations, the partition selection module 309 may select the circuit data corresponding to pins assigned the values of “1,” “2,” and “3” in the first and second data paths as one segment group, and select the circuit data corresponding to pins assigned the values of “1,” “2,” and “3” in the third data path as another segment group. Because both of these segment groups have the same assigned pin (or node) values, they are independent from each other with respect to a timing analysis process. Accordingly, the EDA timing analysis module 311 can analyze the segment groups in parallel using different timing analysis processes.

It should be appreciated that additional parallelization techniques can be used to analyze the selected segments (or segment groups). For example, if the analysis is a multi-corner/multi-mode analysis, then the selected segments (or segment groups) can be analyzed in parallel for different corner/mode combinations.

After the circuit design data has been analyzed by the EDA timing analysis module 311, the results are provided to the analysis results assembly module 313. In operation 509, the analysis results assembly module 313 assembles the timing analysis results into the desired format and stores the results in the timing analysis data storage 315.

### CONCLUSION

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims. For example, while specific terminology has been employed above to refer to electronic design automation processes, it should be appreciated that various examples of the invention may be implemented using any desired combination of electronic design automation processes.

What is claimed is:

1. A method of performing an electronic design automation analysis, comprising
identifying signal paths in a circuit design, such that each signal path contains one or more nodes;
assigning a value to the nodes for each signal path to be analyzed by electronic design automation analysis process;
selecting segments of the circuit design based upon the values assigned to the nodes; and
performing the electronic design automation analysis on two or more of the selected segments in parallel.

2. The method recited in claim 1, wherein the nodes are circuit component pins.
